(19) United States
(12) Patent Application Publication
(10) Pub. No.: US 2026/0186969 A1
(43) Pub. Date: Jul. 2, 2026

(54) MEMORY MODULE AND METHODS THEREOF

(71) Applicant: Ferroelectric Memory GmbH, Dresden (DE)

(72) Inventor: Ayman Abouelwafa, Folsom, CA (US)

(21) Appl. No.: 19/434,592

(22) Filed: Dec. 29, 2025

(51) Int. Cl. G06F 12/0802; G06F 12/02

(52) U.S. Cl. CPC G06F 12/0802; G06F 12/0246

(57) ABSTRACT

Various aspects relate to a memory module including: a memory interface; a storage device for persistently storing data; a non-volatile memory device providing a memory storage for persistently storing data and providing a write buffer configured to receive, via the memory interface, and to store corresponding data to be written to the memory module; and a memory controller configured to write the corresponding data selectively from the write buffer to the storage device or to the memory storage.

### TECHNICAL FIELD

Various aspects relate to a memory module and methods thereof (e.g., a method for writing data to the memory module and a method for caching data in the memory module).

### BACKGROUND

In general, various computer memory technologies have been developed in semiconductor industry. Various memory devices, such as solid-state discs (SSD), include a non-volatile (e.g., flash) storage for persistently storing data and a volatile dynamic random-access memory (DRAM) that provides a write cache (which may also be referred to as write buffer) for volatilely storing data that are to be written into the non-volatile storage for persistent storage.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects of the invention are described with reference to the following drawings, in which:

FIG. 1 shows a memory module according to various aspects;

FIG. 2 shows the memory module where a memory storage has pages of different size according to various aspects;

FIG. 3 and FIG. 4 each show a flow diagram of a method for writing data to a memory module according to various aspects; and

FIG. 5 and FIG. 7 each show a flow diagram of a method for caching data in a memory module according to various aspects.

### DESCRIPTION

The following detailed description refers to the accompanying drawings that show, by way of illustration, specific details and aspects in which the invention may be practiced. These aspects are described in sufficient detail to enable those skilled in the art to practice the invention. Other aspects may be utilized and structural, logical, and electrical changes may be made without departing from the scope of the invention. The various aspects are not necessarily mutually exclusive, as some aspects may be combined with one or more other aspects to form new aspects. Various aspects are described in connection with methods and various aspects are described in connection with devices (e.g., a memory cell, or a memory capacitor). However, it may be understood that aspects described in connection with methods may similarly apply to the devices, and vice versa.

Conventionally, a non-volatile (e.g., NAND) (flash) storage of a memory module, such as solid-state discs (SSD), is coupled to a volatile dynamic random-access memory (DRAM) that provides a write and read cache (which may also be referred to as write and read buffer) for volatile storage of data that are to be written into and/or read from the non-volatile storage, thereby increasing the speed of writing data to and/or reading data from the non-volatile storage.

Although the DRAM improves in particular the write speed, its volatility imposes various requirements and limitations on the operation of the memory module.

Various aspects detailed herein relate to a memory module including a non-volatile memory (device) that provides a write cache and/or read cache. The non-volatile memory allows to omit various requirements of DRAM and/or to overcome limitations of DRAM.

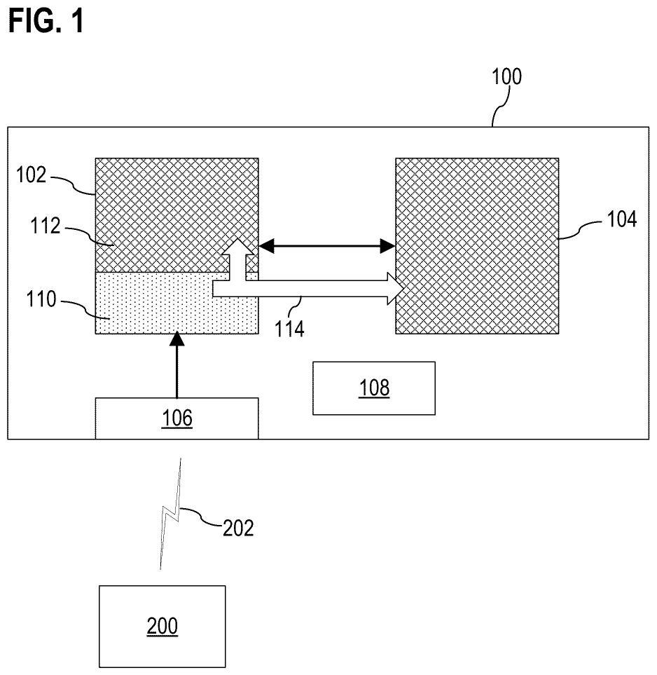

FIG. 1 shows memory module 100 according to various aspects. The memory module 100 may be, for example, an SSD.

The memory module 100 may include a memory controller (short: controller) 108. The memory controller 108 may be configured to control the units of the memory module 100. Thus, the memory controller 108 may be, for example, configured to control read and/or write operations on the memory module 100. Herein, when referring to an action being carried out by at least one of the elements of the memory module 100, the memory controller 108 may be configured to control the at least one element accordingly.

The memory module 100 may include a memory interface 106. The memory interface 106 may be configured to receive data from a host 200 (e.g., a processing unit (e.g., a central processing unit), e.g., of a user device) via a communication channel 202 (e.g., to write the data to the memory module 100). The memory interface 106 may be configured to transmit data to the host 200 via the communication channel 202 (e.g., to provide data that are read from the memory module 100 responsive to the host 200 requesting them). The processing unit of the host 200 may implement an application interacting with the memory module 100 via the memory interface 106. The memory interface 106 may be any kind of interface that allows to address the memory module 100

The memory module 100 may include a non-volatile (e.g., DRAM+) memory device 102 (which may also be referred to as memory device 102 or memory 102) and a (non-volatile) (e.g., NAND) storage device (which may also be referred to as storage device 104 or storage 104).

Conventional memory devices that include a NAND flash storage in combination with DRAM require, due to the volatility of DRAM, (for power loss protection and data integrity) a capacitor, a backup region within the NAND flash storage, and part of the memory controller dedicated to the backup. Upon loss of the power supply (or a firmware update), the capacitor provides power for the backup region of the NAND flash storage (e.g., some NAND chips dedicated for backup), the DRAM (and SRAM), and the memory controller such that data that are volatilely stored in the DRAM (and the FTL table(s) in the SRAM) can be safely written to the NAND flash storage. Illustratively, all volatile data are flushed from DRAM cache (and the FTL table(s) from SRAM) to the NAND flash storage.

Since the non-volatile memory device 102 stores all data persistently, those elements are not required. Hence, the memory module 100 may not include the capacitor and the backup region of the NAND flash storage can be used (in the non-volatile storage device 104) as regular storage. Hence, the memory module 100 may have a smaller footprint (e.g., allowing to use the persistent storage space of the non-volatile memory device 102), lower power requirements, an increased storage density, a faster power-fail recovery (since no backup store and restore is required), no need for paired NAND in the case of multi-bit cells (e.g., QLCs), etc.

The non-volatile storage device 104 may include any kind of memory cells for persistent data storage. In some aspects, the memory cells may be configured as one-bit-cells. Hence, the non-volatile storage device 104 may be a Single-Level Cell (SLC) (e.g., NAND) flash storage. In other aspects, the memory cells may be configured as multi-bit-cells. Hence, the non-volatile storage device 104 may be a Multi-Level Cell (MLC) (e.g., NAND) flash storage storing 2 bits per cell, a Triple-Level Cell (TLC) (e.g., NAND) flash storage storing 3 bits per cell, Quad-Level Cell (QLC) (e.g., NAND) flash storage storing 4 bits per cell, etc.

In general (e.g., when using a volatile memory, such as DRAM), the costs of the non-volatile storage device 104 (and, hence, of the memory module 100) may (for a same total capacity) decrease with increasing number of bits stored per cell and the storage density increases. However, this comes at the cost of decreasing endurance, increasing required write amplification, decreasing write speed, and/or decreasing data retention. For example, SLC-based storage may allow for about 10-30 write per day (WPD) when guaranteeing a 5 year warranty, may have a write amplification in a range from about 1.0 to about 1.2, and may allow for an endurance of about 100.000 (program/erase (P/E)) cycles. For example, MLC-based storage may allow for about 3-10 WPD when guaranteeing the 5 year warranty, may have a write amplification in a range from about 1.2 to about 2.0, and may allow for an endurance of about 10.000 (P/E) cycles. For example, TLC-based storage may allow for about 1-3 WPD when guaranteeing the 5 year warranty, may have a write amplification in a range from about 1.5 to about 4.0, and may allow for an endurance of about 3.000 (P/E) cycles. For example, QLC-based storage may allow for about 0.1-0.5 WPD when guaranteeing the 5 year warranty, may have a write amplification in a range from about 2.0 to about 5.0, and may allow for an endurance of about 1.000 (P/E) cycles. Therefore, conventionally (e.g., when using DRAM) QLC-based storage is only suitable for read-intensive and cost-sensitive applications.

The memory module 100 detailed herein allows to increase the durability of the non-volatile storage device 104, to reduce write amplification, to reduce a number of write operations to the non-volatile memory device 102, etc. Illustratively, the memory module 100 allows to shift the performance of multi-bit cells in direction of SLCs. This allows, for example, to employ the storage density and low cost of QLC-based storage with the performance (e.g., WPD, endurance, write amplification, etc.) of MLCs or even better (e.g., close to SLCs). Hence, the memory module 100 detailed herein allows to use QLC-based storage devices in use-cases that conventionally require MLC-based or even SLC-based storage devices (viz. in current devices using NAND flash storage in combination with DRAM).

According to various aspects, the non-volatile memory device 102 may (be configured to) provide a write (de-stage) buffer 110. Illustratively, a memory portion of the non-volatile memory device 102 may be dedicated to provide the write buffer 110. The write buffer 110 may also be referred to as write cache 110. The write buffer 110 may be configured to receive, via the memory interface 106, data that are to be written to the memory module 100. For example, the write buffer 110 may be configured to receive write transactions that indicate the data to be written to the memory module 100. The write buffer 110 may be configured to store these data (e.g., write transactions indicating the data). Illustratively, the write buffer 110 may be provided in hardware and may be configured to store data persistently.

As an example, the write buffer 110 may be a write first-in first-out (FIFO) buffer. Hence, write transactions written to the write buffer 110 may be written to the memory module 100 (e.g., the non-volatile memory device 102 or the non-volatile storage device 104) in the same order.

According to various aspects, the write buffer 110 may be directly addressable. Hence, the memory interface 106 may be any kind of interface that allows to directly address the write buffer 110. As an example, the memory interface 106 may be a Compute Express Link (CXL) interface.

Compute Express Link (CXL) is an open standard interconnect for high-speed, high-capacity central processing unit (CPU)-to-device and CPU-to-memory connections, designed for high performance data center computers. CXL is built on the serial PCI Express (PCIe) physical and electrical interface and includes PCIe-based block input/output protocol (CXL.io) and cache-coherent protocols for accessing system memory (CXL.cache) and device memory (CXL.mem).

Compute Express Link (CXL) includes a CXL input/output (CXL.io) protocol that allows to address the memory module 100 to, for example, provide new page data (e.g., of 4 kB size) that are to be written to the memory module 104 and/or to provide other data, such as registration data for registering a namespace, etc. Further CXL includes a CXL memory (CXL.mem) protocol that allows to directly address the memory device 102 (with up to 64 kB). According to various aspects, the memory device 102 may be a byte-addressable memory. The CXL.mem protocol is an example of providing the byte-addressability of the memory device 102. It is understood that this serves as an exemplary protocol and that any other protocol may be used that allows to directly (byte-) address the memory device 102. The memory device 102 may also be referred to as host-managed device memory (HDM).

For example, the write buffer 110 may be addressable by at least one predefined physical address (different from the physical addresses at which the page data are stored) using a protocol (e.g., the CXL. mem protocol) providing the direct addressability of the memory device 102. Illustratively, at least one predefined physical address may be used to push packets into a hardware queue of the write (e.g., FIFO) buffer 110. Hence, the at least one predefined physical address may be predefined before the host 200 application starts.

The direct addressability of the memory device 102 (e.g., by using the CXL.mem protocol) allows to write data having a data size less than the page data size (viz. a fraction of page data) to page data of a page, thereby reducing the amount of host-device data movement.

The write buffer 110 allows to move the data transaction management and the thread synchronization to the hardware of the memory module 100. The write buffer 110 scheme described herein may be very suitable for, for example, log structured file systems, in-memory databases (IMDBs), semi-IMDBs (e.g., RocksDB, Redis, etc.), database (DB) logs (e.g., SAP Hana, Oracle, etc.), etc. According to various aspects, the memory controller 108 may be configured to write data associated with an atomic transaction to the memory module 100 in the case that the write buffer 110 stores all packets of this atomic transaction. Illustratively, the data are only written to memory module 100 in the case that there is a complete (or full) atomic transaction, viz. that there are all packets of the atomic transaction available. This ensures data coherency without any access locking. Thus, the data are only written to the memory module 100 once they are coherent. Further, to write (e.g., merge) the data, no further interaction with the host 200 is required, but the write (e.g., merge) operation is carried out completely in hardware by back-pressuring the memory controller 108. This improves the performance of the memory module 100 significantly. To know whether the write buffer 110 stores all packets associated with a same atomic transaction, each packet may include a transaction identifier (ID) indicating its atomic transaction and there may be a direct or indirect indicator indicating that all packets of this atomic transaction are stored in the write buffer 110. For this, a start packet or at least one of the packets of the atomic transaction may include a total number of packets that belong to the atomic transaction and/or the atomic transaction may include an end packet indicating that all packets are received. Using the end packet improves the performance of the memory module 100 since the memory controller 108 does not have to scan the packets in the write buffer 110 in order to determine whether all data packets of an atomic transaction is received and stored in the write buffer 110. Writing incoming data to the write buffer 110 allows to absorb the initial burst of write operations. The write buffer 110 provides a high endurance, fast, and durable access to the memory module 100.

The non-volatile storage device 104 may be a NAND flash storage. Since page data stored in a page in the NAND flash storage cannot be overwritten, pages storing outdated page data (viz. a page or page data indicated as invalid) have to be erased. However, since pages cannot be erased by themselves, but on a block-level only, blocks having only invalid pages have to be generated in order to allow to erase them. For this, in the case that a block still includes some valid pages, the page data stored in these valid pages have to be written (internally) to other pages in the NAND flash storage. This process is called garbage collection. In order to generate a block having invalid pages only, the page data of each valid page of the block may be stored in the write buffer 110 and then written to another page in the NAND flash storage. Once the page data are written to the other page, the previously valid page may be indicated as invalid in the page table and the page metadata may be updated (viz. the physical address of the other page may be linked to the logical address of the page data in the L2P table). Hence, garbage collection may include, for each page storing page data that are to be rewritten to another page, reading the page data to the write buffer 110, writing the page data to the other page on the NAND flash storage, and updating the page metadata (viz. the page table for the initial page (by indicating the initial page as invalid), the page table for the other page by linking the page data to the physical address of the other page, and the L2P table by linking the logical address to the physical address of the other page). Hence, due to receiving page data having a logical address that is associated with a physical address, more and more pages of the NAND flash storage get invalided (viz. store obsolete page data) and, at some point, no erased pages may be available for writing received page data. Therefore, garbage collection may be required in order to ensure that erased pages are available. Thus, the garbage collection may lead to a high number of internal write operations (of rewriting page data on the NAND flash storage). Illustratively, garbage collection may result in a high number of internal write operations which are not intended by the host 200. This may lead to a write amplification, where the number of physical writes (e.g., the actual amount of information physically (e.g., internally and externally) written to the NAND flash storage) is a multiple of the number of logical writes (viz. the logical amount of information (externally) written to the NAND flash storage). Hence, write amplification may indicate that the amount of data physically written to the memory module 100 is higher than the logical amount of data intended to be written to the memory module 100. A high level of write amplification may slow down the input/output (I/O) of the memory module 100 and may worsen the lifespan of the memory module 100.

The non-volatile storage in the write buffer 110 allows to indicate a page of the non-volatile storage device 104 as invalid prior to writing the data to from the write buffer 110 to the non-volatile storage device 104. This accelerates the garbage collection of the non-volatile storage device 104 by allowing to reduce the time of generating new erased blocks (during garbage collection) significantly. Using the non-volatile memory device 102 as write cache allows to detach dirty cached page data in the write buffer 110 from the page data stored in the non-volatile storage device 104, thereby significantly reducing write amplification.

In the case that the host 200 transmits page data to the memory module 100, the memory module 100 may be configured to notify the host 200 that it received the page data. For example, the memory module 100 may be configured to transmit an acknowledgement message to the host 200 indicating reception of the page data. Prior art memory modules having a volatile write cache, such as a DRAM, may be operated in a write cache enabled mode or in a write cache disable mode. In the write cache enable mode, the acknowledgement message may be sent upon storing the received page data in the volatile write cache. Thus, in the event of a system failure, such as a sudden loss of power, the page data stored in the volatile write cache may be lost after sending the acknowledgement message. In the write cache disabled mode, the acknowledgement message may be sent upon writing the received page data into the non-volatile (NAND) flash storage 104. Thus, the acknowledgement message is sent only after non-volatilely storing the received page data. The write cache disabled mode prevents the risk of data loss, but has a reduced performance as compared to the write cache enabled mode. Thus, there has to be a decision whether an increase of performance provided by the write cache enabled mode justifies the risk of data loss. The non-volatile write buffer 110 detailed herein allows to provide both, to prevent the risk of data less while at the same time providing the high performance of the write cache enabled mode. Therefore, the memory controller 108 may be configured to (always) send, (via the memory interface 106) to the host 200 (processing unit), an acknowledgement message to acknowledge data reception prior to writing them to the persistent storage of the non-volatile memory device 102 and/or the non-volatile storage device 104.

According to various aspects, the non-volatile memory device 102 may (be configured to) provide a memory storage (space) 112 for persistently storing data. Hence, both, the non-volatile memory device 102 and the non-volatile storage device 104, may provide space for persistent data storage. The memory module 100 may include (e.g., non-volatilely store) a logical-to-physical (L2P) address translation. A Flash Translation Layer (FTL) may provide the L2P address translation. An L2P table may include a logical block address (short: logical address) and a physical block address (short: physical address) of data stored by the memory module 100 for L2P address translation. Illustratively, the logical addresses may provide an abstract (e.g., virtual) address for software (e.g., the application implemented by the processing unit of the host 200) to interact with the memory module 100, whereas the physical addresses represent actual hardware locations on the memory module 100. The logical block address may also be referred to as virtual block address (short: virtual address). According to various aspects, the L2P table(s) may include the physical addresses of the memory storage (space) 112 of the non-volatile memory device 102 and the physical addresses of a storage space of the non-volatile storage device 104. Hence, the storage space of the non-volatile memory device 102 and of the storage space of the non-volatile storage device 104 may be mapped (by memory mapping, MMAP) to a shared address space. Illustratively, the whole capacity of the memory module 100 may be mapped as (static) addresses. The address space may logically split the non-volatile memory device 102 into the write buffer 110 and the memory storage (space) 112.

Conventionally (e.g., when using DRAM), a ratio between a size of the DRAM serving as write cache and a size of the NAND flash storage is about 1:1000. Therefore, according to various aspects, a ratio between a size of the write buffer 110 and a size of the non-volatile storage device 104 may be about 1:1000. Since the non-volatile memory device 102 may further include the memory storage (space) 112 for persistent data storage, a ratio between a size of the non-volatile memory device 102 and the size of the non-volatile storage device 104 may be larger than about 1:1000 (e.g., 2:1000, 3:1000, 4:1000, etc.).

According to various aspects, the memory controller 108 may be configured to write incoming data selectively from the write buffer 110 either to the storage space of the non-volatile storage device 104 or to the memory storage (space) 112 of the non-volatile memory device 102 (as indicated by arrow 114 in FIG. 1).

In some aspects, the selective writing from the write buffer 110 into either the memory storage (space) 112 or the storage space host-initiated. In this case, a write command (from the host 200) for writing data to the memory module 100 may include metadata that indicate a logical address where the data are to be written to and the shared address space (e.g., the FTL table(s)) may indicate whether this logical address is associated with a location in the memory storage (space) 112 or the storage space of the non-volatile storage device 104. With this, the host 200 can be aware of whether the logical address indicates a location in the memory storage (space) 112 or the storage space of the non-volatile storage device 104.

In further aspects, the selective writing from the write buffer 110 into either the memory storage (space) 112 or the storage space memory-controller-initiated. In this case, the memory controller 108 may be configured to select whether the incoming data are to be written to the memory storage (space) 112 or the storage space.

In even further aspects, the selective writing from the write buffer 110 into either the memory storage (space) 112 or the storage space may be a combination of being host-initiated and memory-controller-initiated. For example, the metadata of the write command (and thus the host 200) may indicate (i) whether the incoming data are to be written to one of the memory storage (space) 112 or the storage space, or (ii) whether the memory controller 108 can decide thereon. Hence, the first case (i) may be host-initiated, whereas in the second case (ii) the memory controller 108 decides.

There are various reasons on why to store the incoming in the memory storage (space) 112 or the storage space.

As an example, the memory storage (space) 112 may allow for a faster read access, wherefore the host 200 may indicate to store the data in the memory storage (space) 112 if it intends to access the data in future (planned) read requests. According to various aspects, the memory storage (space) 112 of the non-volatile memory device 102 may have a first (memory) tier and the storage space of the non-volatile storage device 104 may have a second (storage) tier (e.g., T2) higher than the first tier. For example, the first tier may be T0, thereby providing ultra-high performance and low latency. The host 200 may be aware of the different tier. Hence, the memory storage (space) 112 may be presented to the host as first tier (e.g., T0) storage and the storage space may be presented to the host as second tier (e.g., T2). Thus, the address space may indicate the first tier for the logical addresses associated with the memory storage (space) 112 and the second tier for the logical addresses associated with the storage space.

As a further example, as detailed herein, the memory storage (space) 112 may include pages of different (and optionally variable, dynamic) page size. Therefore, the memory controller 108 and/or the host 200 may be configured to determine, whether the incoming data are to be written to the memory storage (space) 112 or the storage space, depending on a data size of the incoming data. For example, as detailed herein, writing data portions smaller than a page size of the non-volatile storage device 104 allows to consolidate the data portions in the non-volatile memory device 102 and reduces a number of write operations (short: number of writes) on the non-volatile storage device 104, thereby improving its endurance, reducing a required write amplification, improving garbage collection, etc.

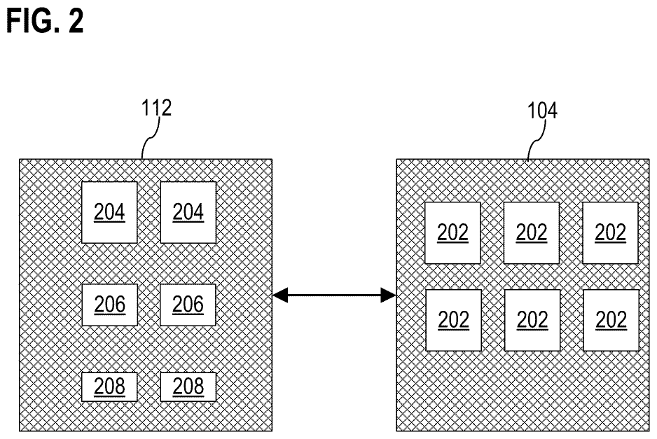

FIG. 2 shows the memory storage (space) 112 and the storage space with such different page sizes according to various aspects.

The non-volatile storage device 104 may include a plurality of pages 202. Each page of the plurality of pages 202 may have a first page size. Hence, all pages of the plurality of pages 202 may have a same page size for storing page data. Thus, when referring to page data in the storage space herein and specifically stating a portion of page data, it may be referred to data having the size of one page. Hence, the term “page” with reference to the non-volatile storage device 104 may refer to a storage region that can store data having the size of one page (short: page size).

As detailed herein, the non-volatile storage device 104 may be a (e.g., NAND) flash storage. A NAND flash storage may include one or more dies (e.g., a package including one or more dies). Each die of the one or more dies may include one or more planes (e.g., exactly one plane or two planes). Each plane of the one or more planes may include a plurality of blocks. Each block of the plurality of blocks may include pages (may also be referred to as page frame). As an example, the first page size may be 4 kB (or larger).

The memory storage (space) 112 may include multiple pages 204, 206, 208 (e.g., small, medium, and large). The multiple pages 204, 206, 208 may have one or more different page sizes. One or more pages 206, 208 of the multiple pages 204, 206, 208 may have a (second) page size less than the first page size. Optionally, the memory storage (space) 112 may include pages 204 having the first page size. For example, as exemplarily shown in FIG. 2, the memory storage (space) 112 may include one or more first pages 204 having the first page size, one or more second pages 206 having a second page size less than the first page size, one or more third pages 208 having a third pages size less than the second page size, etc. The FTL table(s) may indicate the page size of each entry (viz. logical-to-physical address mapping). As an example, the first page size may be 4 kB, the second page size may be 512 Bytes, and the third page size may be 256 Bytes. It is understood that this serves as an example and that the memory storage (space) 112 may include any page size (e.g., depending on the use-case, with 512 Bytes and/or 256 Bytes being, for example, very advantageous for various artificial intelligence (AI) use cases).

In some aspects, the page size(s) and the number of pages of the multiple pages 204, 206, 208 in the memory storage (space) 112 may be predefined. Hence, the multiple pages 204, 206, 208 may be fixed.

In other aspects, the page size(s) and/or the number of pages of the multiple pages 204, 206, 208 in the memory storage (space) 112 may be variable. In this case, the memory controller 108 may be configured to dynamically generate pages having a page size selected from plurality of page sizes. It is understood that, when dynamically generating a page with a correspondingly selected page size, a corresponding entry in the FTL table(s) may be generated that indicates (besides the address mapping) the page size.

According to various aspects, the plurality of page sizes may include the first page size and one or more different pages sizes less than the first page size. Hence, all of the plurality of page sizes may be equal to or less than the first page size.

The dynamic page generation may be dependent on a (e.g., current) data flow to the memory module 100. Hence, depending on a data size of data that the host 200 wants to write to the memory module 100, the memory controller 108 may generate one or more pages having a suitable page size to store these data. It is understood that, as detailed with reference to FIG. 1, incoming data may be selectively written either to the memory storage (space) 112 or to the storage space and that this may be host-initiated and/or memory-controller-initiated. Hence, the memory controller 108 may be configured to dynamically generate one or more pages in the memory storage (space) 112 in the case that the incoming data are to be written to the memory storage (space) 112. Since the storage space only has pages with the first page size and since the memory storage (space) 112 allows for smaller pages (viz. smaller than the first page size) as well, the memory controller 108 may be in the memory-controller-initiated configured to determine, whether incoming data are to be written to the storage space or the memory storage (space) 112 depending on the size of the incoming data. Hence, if the incoming data have a size in accordance with the first page size (and their metadata do not indicate them as to be written to the memory storage (space) 112), the memory controller 108 may determine to write these data to the storage space, whereas in the case that the incoming data have a size less than the first page size, the memory controller 108 may use an available smaller page or may generate a suitable smaller page in the memory storage (space) 112 and store the incoming data therein.

The memory controller 108 may be configured to consolidate data, which are written to pages 206, 208 having a page size less than the first page size, into a page 204 that has the first page size and may then write the page data of this page 204 to the non-volatile storage device 104, thereby reducing a number of writes to the non-volatile storage device 104, thereby increasing its durability.

Thus, the smaller pages in the memory storage (space) 112 allow granular writes to the non-volatile memory device 102. Hence, instead of writing smaller data (viz. data smaller than the first page size) to smaller pages in the memory storage (space) 112 omits unnecessary writes to and rewrites on the non-volatile storage device 104, thereby reducing garbage collection and write amplification. This reduces the space of the non-volatile storage device 104 reserved for garbage collection, thereby increasing the overall usable storage capacity of the non-volatile storage device 104. Thus, a number of program/erase (P/E) cycles of the non-volatile storage device 104 can be reduced significantly, thereby increasing endurance and lifespan of the non-volatile storage device 104. As detailed herein, this allows to use multi-bit cells, such as QLCs, with the performance of MLCs or even SLCs.

Thus, the different (and optionally dynamic) page sizes increase the storage efficiency of the memory module 100.

As detailed herein, the memory storage (space) 112 of the non-volatile memory device 102 allows for a faster read access as compared to the storage space of the non-volatile storage device 104. Therefore, various aspects described herein relate to a caching of data from the storage space to the memory storage (space) 112 (for accelerated read access).

Since the memory storage (space) 112 stores data persistently as well, the term “caching”, used in the context of caching data from the non-volatile storage device 104 to the non-volatile memory device 102, may include that the data are kept in the non-volatile storage device 104 (e.g., the caching may be a copying of the data (such that the data remain in the storage space)) or may include that the data are not kept in the non-volatile storage device 104 (e.g., the caching may be a writing of the data and the page in the storage space that is associated with the data is indicated as invalid). Indicating the page storing the data in the storage space as invalid when caching the data to the memory storage (space) 112 allows to further improve garbage collection.

This caching may be memory-controlled and/or host-controlled. The caching detailed herein allows to accelerate the read access to the memory module 100.

In the case of host-controlled caching, a read request of the host 200 for reading read data stored by the memory module 100 (e.g., the memory storage (space) 112 or the storage space of the non-volatile storage device 104) may additionally indicate target data that are stored by the non-volatile storage device 104 (viz. in the storage space) and that are intended to be read by the host 200 in future read requests. The memory controller 108 may be configured to cache these target data from the storage space to the memory storage (space) 112.

Hence, in the case of memory-controlled caching, the memory controller 108 may determine which data are to be cached.

In the case of memory-controlled caching, the memory controller 108 may be configured to track an access pattern of the host 200. Hence, the memory controller 108 may track the data accessed by the host 200 in the non-volatile storage device 104. This allows the memory controller 108 to determine frequently accessed data in the non-volatile storage device 104. The memory controller 108 may be configured to cache the frequently accessed data from the storage space to the memory storage (space) 112.

Herein, “frequently accessed data” may be data whose number of accesses within a predefined time period is equal to or greater than a predefined threshold number of accesses.

Hence, in the case of host-controlled caching, the host 200 may indicate data to be cached.

In the case of a combination of host-controlled caching and memory-controlled caching, the memory controller 108 may be configured to determine, whether the read request additionally indicates the target data as detailed with reference to the host-controlled case. In the case that the read request additionally indicates the target data, the memory controller 108 may cache these target data to the memory storage (space) 112. The memory controller 108 may determine, whether the data read by the read request are frequently accessed as detailed with reference to the memory-controlled caching. In the case that the read data are frequently accessed, the memory controller 108 may cache the read data from the storage space to the memory storage (space) 112.

The data that are to be cached (viz. the read data are frequently accessed and/or the target data that are intended to be read by the host 200 in future read requests) may be associated with at least one page. The cached data may be all page stored in this at least one page or may be a portion of page data stored in the at least one page.

In the case that the data that are to be cached include only a portion (viz. not all) of the page data, the memory controller 108 may be configured to cache either only this portion or the full page data from the storage space to the memory storage (space) 112. When caching only the portion of the page data to the memory storage (space) 112, the portion of the page data may, for example, be stored in a smaller page 206, 208 of the multiple pages 204, 206, 208 of the non-volatile memory device 102, thereby increasing storage efficiency in the non-volatile memory device 102. Further, this allows for a granular access of the cached data by the host 200. However, in this case the at least one page in the storage space may not be indicated as invalid since there are also non-cached data still stored in this at least one page. Therefore, caching the full page data even in the case that only a portion of these page data is to be cached allows to indicate the at least one page in the storage space as invalid, thereby improving garbage collection. The memory controller 108 may in this case still store the portion of the page data in the smaller page 206, 208 and may consolidate the remaining data with other data in a page 204 having the first page size and may then write this page 204 to the storage space, thereby achieving improved garbage collection and improved storage efficiency. Illustratively, the memory controller 108 may be configured to split the at least one page when caching the at least one page from the storage space to the memory storage (space) 112.

According to various aspects, the memory controller 108 may be configured to selectively (decide to) cache either the full page data or only the portion that is to be cached from the storage space to the memory storage (space) 112 (e.g., depending on a current use-case, a size of the portion (e.g., whether its size is close to the first page size or significantly less), etc.

The functions of the memory module 100 (e.g., as being carried out by the memory controller 108) detailed herein may not require any hardware adaption, but may be implemented by a firmware update.

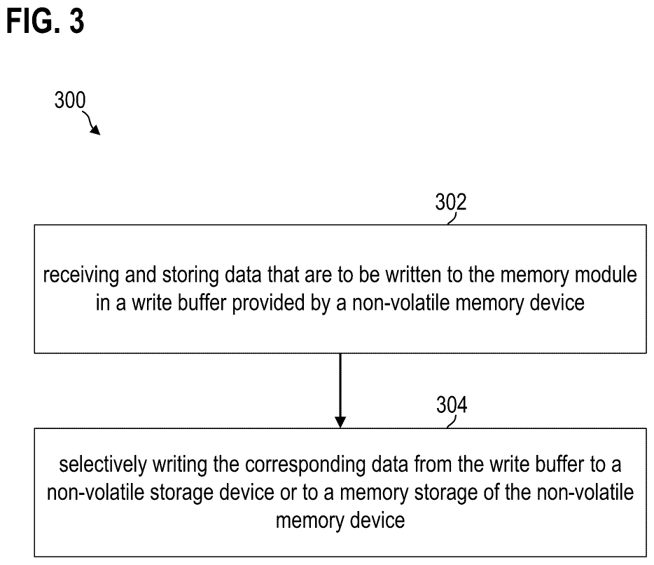

FIG. 3 shows a flow diagram of a method 300 writing data to a memory module including a non-volatile memory device and a (non-volatile) (e.g., NAND) storage device according to various aspects.

The method 300 may include (in 302) receiving (via a memory interface of the memory module) and storing (write transactions, which indicate) corresponding data that are to be written to the memory module in a write (de-stage) buffer provided by the non-volatile memory device.

The method 300 may include (in 304) selectively writing the corresponding data from the write buffer (either) to the storage device or to a memory storage (space) of the non-volatile memory device.

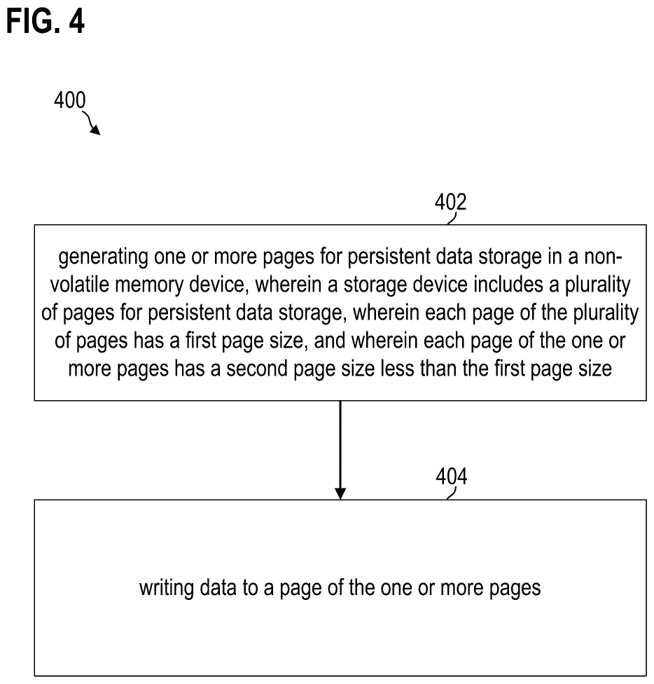

FIG. 4 shows a flow diagram of a method 400 for writing data to a memory module including a non-volatile (e.g., DRAM+) memory device and a (non-volatile) (e.g., NAND) storage device according to various aspects.

The method 400may include (in 402) generating one or more pages for persistent data storage in the non-volatile memory device, wherein the storage device includes a plurality of pages for persistent data storage, wherein each page of the plurality of pages has a first page size (e.g., 4 kB), and wherein each page of the one or more pages has a second page size less than the first page size.

The method 400may include (in 404) writing data to a page of the one or more pages.

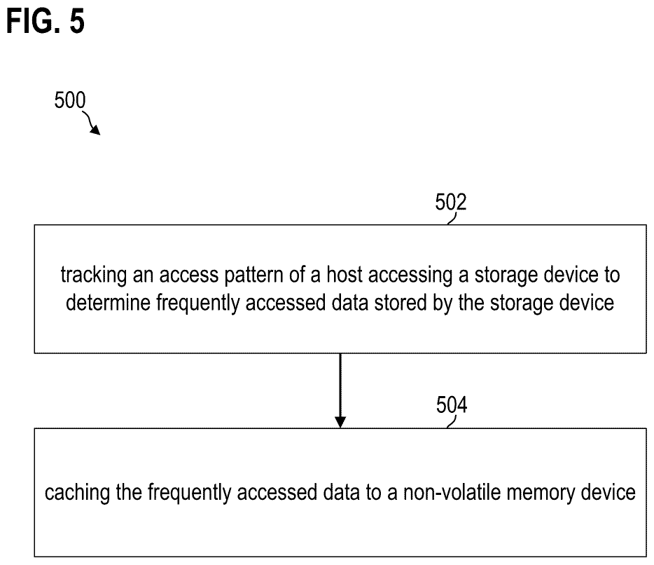

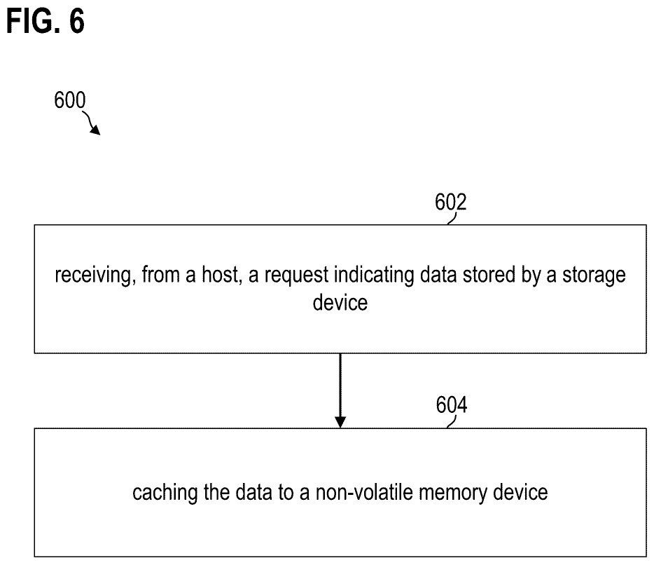

FIG. 5 shows a flow diagram of a method 500 for caching data in a memory module that includes a non-volatile (e.g., DRAM+) memory device and a (non-volatile) (e.g., NAND) storage device according to various aspects.

The method 500 may include (in 502) tracking an access pattern of a host (processing unit) accessing the storage device to determine frequently accessed data stored by the storage device.

The method 500 may include (in 504) caching the frequently accessed data (from the storage device) to the non-volatile memory device.

FIG. 6 shows a flow diagram of a method 600 for caching data in a memory module that includes a non-volatile (e.g., DRAM+) memory device and a (non-volatile) (e.g., NAND) storage device according to various aspects.

The method 600 may include (in 602) receiving, from a host (processing unit), a (e.g., read) request indicating data stored by the storage device.

The method 600 may include (in 604) caching the data (from the storage device) to the (memory storage of the) non-volatile memory device.

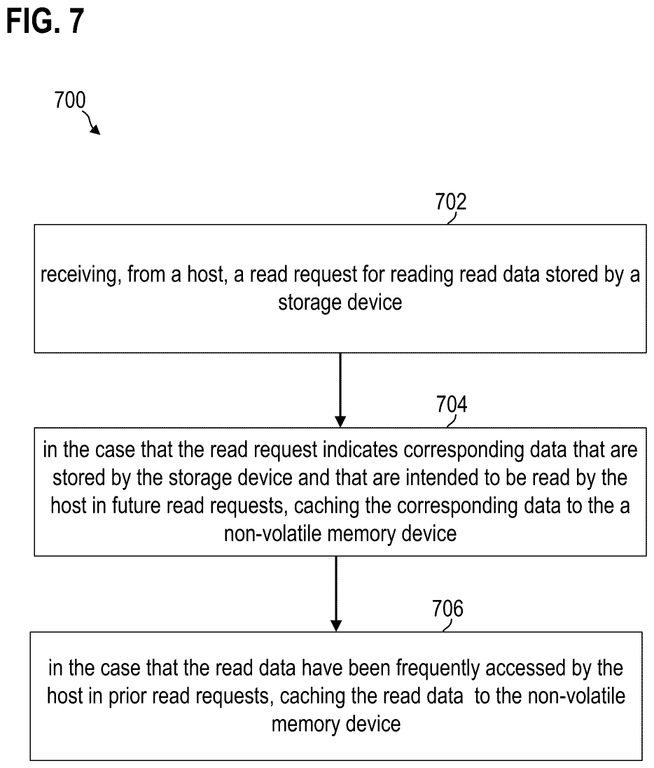

FIG. 7 shows a flow diagram of a method 700 for caching data in a memory module that includes a non-volatile (e.g., DRAM+) memory device and a (non-volatile) (e.g., NAND) storage device according to various aspects.

The method 700 may include (in 702) receiving, from a host (processing unit), a read request for reading read data stored by the memory module.

The method 700 may include (in 704) in the case that the read request indicates corresponding data that are stored by the storage device and that are intended to be read by the host in future read requests, caching the corresponding data to the non-volatile memory device.

For example, the method 700 may include determining, whether the read request indicates corresponding data that are stored by the storage device and that are intended to be read by the host in future read requests, and may include, in the case that it is determined that the read request indicates the corresponding data, caching the corresponding data (from the storage device) to the (memory storage of the) non-volatile memory device (for future read access).

The method 700 may include (in 706) in the case that the read data have been frequently accessed by the host in prior read requests, caching the read data to the non-volatile memory device.

For example, the method 700 may include determining, whether the read data have been frequently accessed by the host in prior read requests, and may include, in the case that it is determined that the read data have been frequently accessed by the host in prior read requests, caching the read data (from the storage device) to the (memory storage of the) non-volatile memory device (for future read access).

It may be intended that aspects described in relation to one or more of the methods may apply also to the memory module, and vice versa. For example, a method may include an execution of one or more functions described with reference to the memory device. For example, the memory controller 108 of the memory module 100 may be configured to carry out one or more aspects described herein.

In the following, various examples are provided that may include one or more aspects described above with reference to the memory module 100 and to the methods described herein. It may be intended that aspects described in relation to one or more of the methods may apply also to the memory module 100, and vice versa.

Example 1 is a (computer-readable) memory module including: a memory interface; a (non-volatile) (e.g., NAND) storage device for persistently storing data; a non-volatile (e.g., DRAM+) memory device providing a memory storage (space) for persistently storing data and providing a write (de-stage) buffer configured to receive, via the memory interface, and to store (write transactions that indicate) corresponding data to be written to the memory module; and a memory controller configured to write the corresponding data selectively from the write buffer (either) to the storage device or to the memory storage (of the non-volatile memory device).

Due to the non-volatile data storage in the memory device (such as DRAM+), the (e.g., SSD) memory module does not require various elements that are commonly (e.g., in the case of a DRAM-based write cache) required for power-loss protection and data integrity scenarios, such as a capacitor, a reserved (backup) space in the (e.g., NAND) storage device, a backup-related region of the memory controller, a static random-access memory (SRAM), etc., thereby increasing storage density and reducing power requirements. Persistently storing data in the non-volatile memory device reduces a number of write operations to the storage device, thereby increasing a durability of the storage device.

In Example 2, the subject matter of Example 1 can optionally include that the memory controller is configured to write the corresponding data in response to receiving, from a host (processing unit), a write command indicating whether the corresponding data are to be written to the storage device or to the memory storage (of the non-volatile memory device).

In Example 3, the subject matter of Example 2 can optionally include that the write command includes metadata indicating an (logical block) address where the corresponding data are to be written to, wherein a translation layer indicates whether the address is associated with a location in the storage device or the memory storage. Thus, the host (processing unit) is aware of whether the (logical block) address indicates a (physical block dress) location in the storage device or the memory storage (of the non-volatile memory).

In Example 4, the subject matter of any one of Examples 1 to 3 can optionally include that the memory controller is configured to select whether the corresponding data are to be written to the storage device or to the memory storage (of the non-volatile memory device).

In Example 5, the subject matter of Example 4 can optionally include that the memory controller is configured to select whether the corresponding data are to be written to the storage device or to the memory storage (of the non-volatile memory device) depending on a data size of the corresponding data.

In Example 6, the subject matter of any one of Examples 1 to 5 can optionally include that the memory controller is configured to, in the case that the corresponding data are to be written to the (e.g., NAND) storage device, indicate a page of the storage device as invalid prior to writing the corresponding data to (an e.g., erased page of) the storage device, wherein the corresponding data represent an (data) update to page data stored by the page.

In Example 7, the subject matter of Example 6 can optionally include that the memory controller is configured to copy (from the storage device) page data to the memory storage prior to indicating the page as invalid.

This earlier indication of pages as invalid (viz. prior to writing the data to the storage device), in accordance with Examples 6 and 7, accelerates the garbage collection of the (NAND) storage device. Due to the accelerated garbage collection, the overprovisioning of the (NAND) storage device is reduced.

In Example 8, the subject matter of any one of Examples 1 to 7 can optionally include that the memory controller is configured to (always) send, (via the memory interface) to the host (processing unit), an acknowledgement message to acknowledge writing of the corresponding data prior to selectively writing the corresponding data from the write buffer (either) to the storage device or to the memory storage.

In Example 9, the subject matter of any one of Examples 1 to 8 can optionally include that a first size of the storage device is less than one thousand times larger than a second size of the memory storage (of the non-volatile memory device).

Commonly, when combining NAND storage with DRAM, a ratio between a size of the DRAM serving as write cache and a size of the NAND storage is about 1:1000. Using a larger ratio (e.g., 2:1000, 3:1000, 4:1000, etc.) in the present case where the memory device stores data persistently allows to employ the additional space in the memory device for persistent data storage.

In Example 10, the subject matter of any one of Examples 1 to 9 can optionally include that the memory storage (of the non-volatile memory device) has a first (memory) tier (e.g., T0) and wherein the storage device has a second (storage) tier (e.g., T2) higher than the first tier.

As an example, the first (memory) tier may be T0, thereby providing ultrahigh performance and low latency.

Example 11 is a method for writing data to a memory module including a non-volatile memory device and a (non-volatile) (e.g., NAND) storage device, the method including: receiving (via a memory interface of the memory module) and storing (write transactions, which indicate) corresponding data that are to be written to the memory module in a write (de-stage) buffer provided by the non-volatile memory device; and selectively writing the corresponding data from the write buffer (either) to the storage device or to a memory storage (space) of the non-volatile memory device.

In Example 12, the method of Example 11 can optionally further include: receiving, from a host (processing unit), a write command indicating whether the corresponding data are to be written to the storage device or to the memory storage (of the non-volatile memory device).

In Example 13, the subject matter of Example 12 can optionally include that the write command includes metadata indicating an (logical block) address where the corresponding data are to be written to, wherein a translation layer indicates whether the address is associated with a location in the storage device or the memory storage. Thus, the host (processing unit) is aware of whether the (logical block) address indicates a (physical block dress) location in the storage device or the memory storage (of the non-volatile memory).

In Example 14, the method of Example 11 can optionally further include: selecting whether the corresponding data are to be written to the storage device or to the memory storage (of the non-volatile memory device).

In Example 15, the method of Example 11 can optionally further include: selecting whether the corresponding data are to be written to the storage device or to the memory storage (of the non-volatile memory device) depending on a data size of the corresponding data.

In Example 16, the method of any one of Examples 11 to 15 can optionally further include: in the case that the corresponding data are to be written to the (e.g., NAND) storage device, indicating a page of the storage device as invalid prior to writing the corresponding data to (an e.g., erased page of) the storage device, wherein the corresponding data represent an (data) update to page data stored by the page.

In Example 17, the method of Example 16 can optionally further include: copying (from the storage device) page data to the memory storage prior to indicating the page as invalid.

In Example 18, the method of any one of Examples 11 to 17 can optionally further include: sending, (via the memory interface) to the host (processing unit), an acknowledgement message to acknowledge writing of the corresponding data prior to selectively writing the corresponding data from the write buffer (either) to the storage device or to the memory storage.

In Example 19, the subject matter of any one of Examples 11 to 18 can optionally include that a first size of the storage device is less than one thousand times larger than a second size of the memory storage (of the non-volatile memory device).

In Example 20, the subject matter of any one of Examples 11 to 19 can optionally include that the memory storage (of the non-volatile memory device) has a first (memory) tier (e.g., T0) and wherein the storage device has a second (storage) tier (e.g., T2) higher than the first tier.

Example 21 is a (computer-readable) memory module including: a memory interface; a (non-volatile) (e.g., NAND) storage device including (e.g., containing) a plurality of pages for persistent data storage, wherein each page of the plurality of pages has a first page size (e.g., 4 kB); a non-volatile (e.g., DRAM+) memory device including one or more pages for persistent data storage, wherein each page of the one or more pages has a second page size less than the first page size; and a memory controller configured to carry out a write operation for writing data (that are received via the memory interface) to a page of the one or more pages.

The smaller pages of the non-volatile (e.g., DRAM+) memory device allow granular writes to the memory module, thereby reducing garbage collection and a corresponding reserved space of the (e.g., NAND) storage device as well as increasing a storage density of the memory module. Further, having smaller pages in the non-volatile memory device allows to consolidate data stored in multiple smaller pages before moving them to a larger page of the storage device, thereby reducing a write amplification of the storage device. This further reduces a number of writes to the storage device, thereby increasing its durability.

In Example 22, the subject matter of Example 21 can optionally include that the memory controller is configured to dynamically generate the one or more pages with the second page size being selected from a plurality of page sizes (and to generate corresponding addresses for the one or more pages).

In Example 23, the subject matter of Example 22 can optionally include that the memory controller is configured to dynamically select the second page size depending on a (e.g., current) data flow to the memory module.

In Example 24, the subject matter of Example 21 can optionally include that the memory controller is configured to dynamically generate multiple pages (and to generate corresponding addresses), wherein each page of the multiple pages has a respective page size selected from a plurality of page sizes, wherein a first page of the multiple pages has a first respective page size (e.g., 512 Bytes) and wherein a second page of the multiple pages has a second respective page size (e.g., 256 Bytes) different from the first respective page size (and optionally different from the first page size) (wherein optionally the multiple pages include the one or more pages).

Examples 22 to 24 allow to dynamically decide which page size(s) are advantageous in a current scenario. Illustratively, this may result in that the non-volatile (e.g., DRAM+) memory device includes many pages with different page sizes (viz. different granularity), thereby allowing to store incoming data to a most suitable page (e.g., which has a minimum page size capable to store the data), thereby increasing storage efficiency. For example, using page sizes of 512 Bytes or smaller may be very advantageous for various artificial intelligence (AI) use cases.

In Example 25, the subject matter of any one of Examples 22 to 24 can optionally include that the non-volatile memory device is configured to store at least one Flash Translation Layer, FTL, table; and wherein the memory controller is configured to, when generating a page having a page size selected from a plurality of page sizes, generate a corresponding address (translation) entry in the at least one FTL table (wherein the corresponding address entry indicates a location of the page in the non-volatile memory device).

In Example 26, the subject matter of any one of Examples 21 to 25 can optionally include that the non-volatile memory device (is configured to) provides a write (de-stage) buffer configured to receive, via the memory interface, and to store (write transactions that indicate) corresponding data that are to be written to the memory module; wherein the memory controller is configured to write the corresponding data selectively from the write buffer (either) to a page of the plurality of pages (of the non-volatile storage device) or of the one or more pages (of the non-volatile memory device).

In Example 27, the subject matter of any one of Examples 21 to 26 can optionally include that the memory controller is configured to select whether the corresponding data are to be written to a page of the plurality of pages (of the non-volatile storage device) or of the one or more pages (of the non-volatile memory device) depending on a size of the corresponding data.

In Example 28, the subject matter of any one of Examples 21 to 27 can optionally include that the non-volatile (e.g., DRAM+) memory device includes multiple pages that include the one or more pages, wherein each page of the multiple pages stores respective data; and wherein the memory controller is configured to write the respective data stored in two or more pages of the multiple pages to a (further) page of the plurality of pages (in the storage device).

Illustratively, two or more smaller data portions (stored by the two or more pages of the non-volatile memory device) may be combined (e.g., consolidated) to one page of the storage device. This reduces a number of writes to the storage device, thereby increasing its durability.

Example 29 is a method for writing data to a memory module including a non-volatile (e.g., DRAM+) memory device and a (non-volatile) (e.g., NAND) storage device, the method including: generating one or more pages for persistent data storage in the non-volatile memory device, wherein the storage device includes a plurality of pages for persistent data storage, wherein each page of the plurality of pages has a first page size (e.g., 4 kB), and wherein each page of the one or more pages has a second page size less than the first page size; and writing data to a page of the one or more pages.

In Example 30, the method of Example 29 can optionally further include: dynamically generating the one or more pages with the second page size being selected from a plurality of page sizes (and to generate corresponding addresses for the one or more pages).

In Example 31, the method of Example 30 can optionally further include: dynamically selecting the second page size depending on a (e.g., current) data flow to the memory module.

In Example 32, the method of Example 29 can optionally further include: dynamically generating multiple pages (and to generate corresponding addresses), wherein each page of the multiple pages has a respective page size selected from a plurality of page sizes, wherein a first page of the multiple pages has a first respective page size (e.g., 512 Bytes) and wherein a second page of the multiple pages has a second respective page size (e.g., 256 Bytes) different from the first respective page size (and optionally different from the first page size) (wherein optionally the multiple pages include the one or more pages).

In Example 33, the subject matter of any one of Examples 29 to 32 can optionally include that the non-volatile memory device stores at least one Flash Translation Layer, FTL, table; and wherein the method further includes, when generating a page having a page size selected from a plurality of page sizes, generating a corresponding address (translation) entry in the at least one FTL table (wherein the corresponding address entry indicates a location of the page in the non-volatile memory device).

In Example 34, the method of any one of Examples 29 to 33 can optionally further include: wherein the non-volatile memory device (is configured to) provides a write (de-stage) buffer configured to receive, via the memory interface, and to store (write transactions that indicate) corresponding data that are to be written to the memory module; and writing the corresponding data selectively from the write buffer (either) to a page of the plurality of pages (of the non-volatile storage device) or of the one or more pages (of the non-volatile memory device).

In Example 35, the method of Example 34 can optionally further include: selecting whether the corresponding data are to be written to a page of the plurality of pages (of the non-volatile storage device) or of the one or more pages (of the non-volatile memory device) depending on a size of the corresponding data.

In Example 36, the subject matter of any one of Examples 29 to 35 can optionally include that the non-volatile (e.g., DRAM+) memory device includes multiple pages that include the one or more pages, wherein each page of the multiple pages stores respective data; and wherein the method further includes writing the respective data stored in two or more pages of the multiple pages to a (further) page of the plurality of pages (in the storage device).

Example 37 is a (computer-readable) memory module including: a memory interface; a (non-volatile) (e.g., NAND) storage device for persistently storing data; a non-volatile (e.g., DRAM+) memory device (providing a memory storage) for persistently storing data; and a memory controller configured to: track an access pattern of a host (processing unit) accessing the storage device to determine frequently accessed data stored by the storage device, and cache the frequently accessed data (from the storage device) to the (memory storage of the) non-volatile memory device.

In Example 38, the subject matter of Example 37 can optionally include that the frequently accessed data are associated with at least one page (of a plurality of pages) of the storage device.

The frequently accessed data may be all page data stored in a page, a portion of page data stored in a page, and/or a least a respective portion of data stored in multiple pages.

In Example 39, the subject matter of Example 37 or 38 can optionally include that the frequently accessed data are a portion of page data stored in a page (of a plurality of pages) of the storage device, wherein the page has a first (NAND) page size (e.g., 4 kB); wherein the memory controller is configured to cache the frequently accessed data (from the storage device) to the non-volatile memory device by writing the portion of the page data (from the page of the storage device) to a memory page of the non-volatile memory device, wherein the memory page has a second page size less than the first page size.

Illustratively, the non-volatile (e.g., DRAM+) memory device can include smaller pages than the NAND allowing for granular data storage as well as granular access by the host.

In Example 40, the subject matter of any one of Examples 37 to 39 can optionally include that the memory controller is configured to determine data stored by the storage device as the frequently accessed data based on (e.g., using) a number of read requests (received from the host) for reading the data.

Example 41 is a method for caching data in a memory module that includes a non-volatile (e.g., DRAM+) memory device and a (non-volatile) (e.g., NAND) storage device, the method including: tracking an access pattern of a host (processing unit) accessing the storage device to determine frequently accessed data stored by the storage device; and caching the frequently accessed data (from the storage device) to the non-volatile memory device.

In Example 42, the subject matter of Example 41 can optionally include that the frequently accessed data are associated with at least one page (of a plurality of pages) of the storage device.

In Example 43, the subject matter of Example 41 or 42 can optionally include that the frequently accessed data are a portion of page data stored in a page (of a plurality of pages) of the storage device, wherein the page has a first (NAND) page size (e.g., 4 kB); wherein the method further includes caching the frequently accessed data (from the storage device) to the non-volatile memory device by writing the portion of the page data (from the page of the storage device) to a memory page of the non-volatile memory device, wherein the memory page has a second page size less than the first page size.

In Example 44, the subject matter of any one of Examples 41 to 43 can optionally include that the method further includes determining data stored by the storage device as the frequently accessed data based on (e.g., using) a number of read requests (received from the host) for reading the data.

Example 45 is a (computer-readable) memory module including: a memory interface; a (non-volatile) (e.g., NAND) storage device for persistently storing data; a non-volatile (e.g., DRAM+) memory device (providing a memory storage) for persistently storing data; and a memory controller configured to: receive, from a host (processing unit) via the memory interface, a (e.g., read) request indicating data stored by the storage device, and cache the data (from the storage device) to the (memory storage of the) non-volatile memory device (for future read access).

Illustratively, the host may indicate the data it intends to read in future read accesses and these data can be cached to the memory device to accelerate these future read accesses.

In Example 46, the subject matter of Example 45 can optionally include that the request indicates that the host intends to read the data (stored by the storage device) in future read requests.

In Example 47, the subject matter of Example 46 can optionally include that the data are a portion of page data stored in a page (of a plurality of pages) of the storage device, wherein the page has a first (NAND) page size (e.g., 4 kB); wherein the memory controller is configured to cache the data (from the storage device) to the non-volatile memory device by writing the portion of the page data (from the page of the storage device) to a memory page of the non-volatile memory device, wherein the memory page has a second page size less than the first page size.

In Example 48, the subject matter of any one of Examples 45 to 47 can optionally include that the request is a read request for reading part of the data.

Illustratively, the host may read some data and at the same time indicate other data it intends to read in future read requests. This allows the memory device to cache (as much as possible of) the other data to accelerate the read operations of the future read requests.

Example 49 is a method for caching data in a memory module that includes a non-volatile (e.g., DRAM+) memory device and a (non-volatile) (e.g., NAND) storage device, the method including: receiving, from a host (processing unit), a (e.g., read) request indicating data stored by the storage device, and caching the data (from the storage device) to the (memory storage of the) non-volatile memory device.

In Example 50, the subject matter of Example 49 can optionally include that the request indicates that the host intends to read the data (stored by the storage device) in future read requests.

In Example 51, the subject matter of Example 50 can optionally include that the data are a portion of page data stored in a page (of a plurality of pages) of the storage device, wherein the page has a first (NAND) page size (e.g., 4 kB); wherein the method further includes caching the data (from the storage device) to the non-volatile memory device by writing the portion of the page data (from the page of the storage device) to a memory page of the non-volatile memory device, wherein the memory page has a second page size less than the first page size.

In Example 52, the subject matter of any one of Examples 49 to 51 can optionally include that the request is a read request for reading part of the data.

Example 53 is a (computer-readable) memory module including: a memory interface; a (non-volatile) (e.g., NAND) storage device for persistently storing data; a non-volatile (e.g., DRAM+) memory device (providing a memory storage) for persistently storing data; and a memory controller configured to: receive, from a host (processing unit) via the memory interface, a read request for reading read data stored by the memory module (e.g., the non-volatile memory device or the storage device), determine, whether the read request indicates corresponding data that are stored by the storage device and that are intended to be read by the host in future read requests, in the case that it is determined that the read request indicates the corresponding data, cache the corresponding data (from the storage device) to the (memory storage of the) non-volatile memory device (for future read access), determine, whether the read data have been frequently accessed by the host in prior read requests, and in the case that it is determined that the read data have been frequently accessed by the host in prior read requests, cache the read data (from the storage device) to the (memory storage of the) non-volatile memory device (for future read access).

In Example 54, the subject matter of Example 53 can optionally include that the memory controller is configured to: determine a number of prior read requests that accessed the read data (in a predefined time period); and determine that the read data have been frequently accessed by the host in the case that the number of prior read requests is equal to or greater than a predefined read access threshold value.

Example 55 is a method for caching data in a memory module that includes a non-volatile (e.g., DRAM+) memory device and a (non-volatile) (e.g., NAND) storage device, the method including: receiving, from a host (processing unit), a read request for reading read data stored by the memory module; determining, whether the read request indicates corresponding data that are stored by the storage device and that are intended to be read by the host in future read requests; in the case that it is determined that the read request indicates the corresponding data, caching the corresponding data (from the storage device) to the (memory storage of the) non-volatile memory device (for future read access); determining, whether the read data have been frequently accessed by the host in prior read requests, and in the case that it is determined that the read data have been frequently accessed by the host in prior read requests, caching the read data (from the storage device) to the (memory storage of the) non-volatile memory device (for future read access).

In Example 56, the method of Example 55 can optionally further include: determining a number of prior read requests that accessed the read data (in a predefined time period); and determining that the read data have been frequently accessed by the host in the case that the number of prior read requests is equal to or greater than a predefined read access threshold value.

In Example 57, the subject matter of any one of Examples 1 to 56 can optionally include that the non-volatile memory device is a remanent-polarizable (e.g., ferroelectric) memory device.

In Example 58, the subject matter of any one of Examples 1 to 57 can optionally include that the memory interface is a Compute Express Link, CXL, interface.

In Example 59, the subject matter of any one of Examples 1 to 58 can optionally include that the memory module is a solid-state disc (SSD).

In Example 60, the subject matter of any one of Examples 1 to 59 can optionally include that the non-volatile storage device includes Quad-Level (memory) Cells (QLC).

The memory module(s) of the Examples described herein allow to increase the durability of the storage device, to reduce write amplification, to reduce a number of write operations to the storage device, etc., thereby allowing to use QLC-based storage devices in use-cases that currently require multi-level cell (MLC) or single-level cell (SLC) based storage devices when being combined with DRAM (instead of DRAM+detailed herein). The use of QLC-based storage devices (instead of MLC-based or SLC-based storage devices) allows to reduce the costs.

In Example 61, the subject matter of any one of Examples 1 to 60 can optionally include that the non-volatile memory device (is configured to) stores at least one Flash Translation Layer (FTL) table.

Example 62 is a (computer-readable) memory module including: a memory interface; a (non-volatile) (e.g., NAND) storage device for persistent data storage; a non-volatile (e.g., DRAM+) memory device for persistently storing data; and a memory controller.

In Example 63, the subject matter of Example 62 can optionally include that the non-volatile (e.g., DRAM+) memory device provides a memory storage (space) for the persistent data storage and provides a write (de-stage) buffer configured to receive, via the memory interface, and to store (write transactions that indicate) corresponding data to be written to the memory module; and wherein the memory controller is configured to write the corresponding data selectively from the write buffer (either) to the storage device or to the memory storage (of the non-volatile memory device).

In Example 64, the subject matter of Example 63 can optionally include that the memory controller is configured to write the corresponding data in response to receiving, from a host (processing unit), a write command indicating whether the corresponding data are to be written to the storage device or to the memory storage (of the non-volatile memory device).

In Example 65, the subject matter of Example 64 can optionally include that the write command includes metadata indicating an (logical block) address where the corresponding data are to be written to, wherein a translation layer indicates whether the address is associated with a location in the storage device or the memory storage. Thus, the host (processing unit) is aware of whether the (logical block) address indicates a (physical block dress) location in the storage device or the memory storage (of the non-volatile memory).

In Example 66, the subject matter of any one of Examples 63 to 65 can optionally include that the memory controller is configured to select whether the corresponding data are to be written to the storage device or to the memory storage (of the non-volatile memory device).

In Example 67, the subject matter of Example 66 can optionally include that the memory controller is configured to select whether the corresponding data are to be written to the storage device or to the memory storage (of the non-volatile memory device) depending on a data size of the corresponding data.

In Example 68, the subject matter of any one of Examples 63 to 67 can optionally include that the memory controller is configured to, in the case that the corresponding data are to be written to the (e.g., NAND) storage device, indicate a page of the storage device as invalid prior to writing the corresponding data to (an e.g., erased page of) the storage device, wherein the corresponding data represent an (data) update to page data stored by the page.

In Example 69, the subject matter of Example 68 can optionally include that the memory controller is configured to copy (from the storage device) page data to the memory storage prior to indicating the page as invalid.

In Example 70, the subject matter of any one of Examples 63 to 69 can optionally include that the memory controller is configured to (always) send, (via the memory interface) to the host (processing unit), an acknowledgement message to acknowledge writing of the corresponding data prior to selectively writing the corresponding data from the write buffer (either) to the storage device or to the memory storage.

In Example 71, the subject matter of any one of Examples 63 to 70 can optionally include that a first size of the storage device is less than one thousand times larger than a second size of the memory storage (of the non-volatile memory device).

In Example 72, the subject matter of any one of Examples 63 to 71 can optionally include that the memory storage (of the non-volatile memory device) has a first (memory) tier (e.g., T0) and wherein the storage device has a second (storage) tier (e.g., T2) higher than the first tier.

In Example 73, the subject matter of any one of Examples 62 to 72 can optionally include that the (non-volatile) (e.g., NAND) storage device includes (e.g., contains) a plurality of pages for the persistent data storage, wherein each page of the plurality of pages has a first page size (e.g., 4kB); wherein the non-volatile (e.g., DRAM+) memory device includes one or more pages for the persistent data storage, wherein each page of the one or more pages has a second page size less than the first page size; and wherein the memory controller is configured to, in the case that the corresponding data are to be written to the (memory device, write the corresponding data to a page of the one or more pages.

In Example 74, the subject matter of Example 73 can optionally include that the memory controller is configured to dynamically generate the one or more pages with the second page size being selected from a plurality of page sizes (and to generate corresponding addresses for the one or more pages).

In Example 75, the subject matter of Example 74 can optionally include that the memory controller is configured to dynamically select the second page size depending on a (e.g., current) data flow to the memory module.

In Example 76, the subject matter of Example 73 can optionally include that the memory controller is configured to dynamically generate multiple pages (and to generate corresponding addresses), wherein each page of the multiple pages has a respective page size selected from a plurality of page sizes, wherein a first page of the multiple pages has a first respective page size (e.g., 512 Bytes) and wherein a second page of the multiple pages has a second respective page size (e.g., 256 Bytes) different from the first respective page size (and optionally different from the first page size) (wherein optionally the multiple pages include the one or more pages).

In Example 77, the subject matter of any one of Examples 73 to 76 can optionally include that the non-volatile memory device is configured to store at least one Flash Translation Layer, FTL, table; and wherein the memory controller is configured to, when generating a page having a page size selected from a plurality of page sizes, generate a corresponding address (translation) entry in the at least one FTL table (wherein the corresponding address entry indicates a location of the page in the non-volatile memory device).

In Example 78, the subject matter of any one of Examples 73 to 77 can optionally include that the non-volatile memory device (is configured to) provides a write (de-stage) buffer configured to receive, via the memory interface, and to store (write transactions that indicate) corresponding data that are to be written to the memory module; wherein the memory controller is configured to write the corresponding data selectively from the write buffer (either) to a page of the plurality of pages (of the non-volatile storage device) or of the one or more pages (of the non-volatile memory device).

In Example 79, the subject matter of Example 78 can optionally include that the memory controller is configured to select whether the corresponding data are to be written to a page of the plurality of pages (of the non-volatile storage device) or of the one or more pages (of the non-volatile memory device) depending on a size of the corresponding data.

In Example 80, the subject matter of any one of Examples 73 to 79 can optionally include that the non-volatile (e.g., DRAM+) memory device includes multiple pages that include the one or more pages, wherein each page of the multiple pages stores respective data; and wherein the memory controller is configured to write the respective data stored in two or more pages of the multiple pages to a (further) page of the plurality of pages (in the storage device).

In Example 81, the subject matter of any one of Examples 62 to 80 can optionally include that the memory controller configured to: track an access pattern of a host (processing unit) accessing the storage device to determine frequently accessed data stored by the storage device, and cache the frequently accessed data (from the storage device) to the (memory storage of the) non-volatile memory device.

In Example 82, the subject matter of Example 81 can optionally include that the frequently accessed data are associated with at least one page (of a plurality of pages) of the storage device.

In Example 83, the subject matter of Example 81 or 82 can optionally include that the frequently accessed data are a portion of page data stored in a page (of a plurality of pages) of the storage device, wherein the page has a first (NAND) page size (e.g., 4 kB); wherein the memory controller is configured to cache the frequently accessed data (from the storage device) to the non-volatile memory device by writing the portion of the page data (from the page of the storage device) to a memory page of the non-volatile memory device, wherein the memory page has a second page size less than the first page size.

In Example 84, the subject matter of any one of Examples 81 to 83 can optionally include that the memory controller is configured to determine data stored by the storage device as the frequently accessed data based on (e.g., using) a number of read requests (received from the host) for reading the data.

In Example 85, the subject matter of any one of Examples 62 to 84 can optionally include that the memory controller configured to: receive, from a host (processing unit) via the memory interface, a (e.g., read) request indicating data stored by the storage device, and cache the data (from the storage device) to the (memory storage of the) non-volatile memory device (for future read access).

In Example 86, the subject matter of Example 85 can optionally include that the request indicates that the host intends to read the data (stored by the storage device) in future read requests.

In Example 87, the subject matter of Example 86 can optionally include that the data are a portion of page data stored in a page (of a plurality of pages) of the storage device, wherein the page has a first (NAND) page size (e.g., 4 kB); wherein the memory controller is configured to cache the data (from the storage device) to the non-volatile memory device by writing the portion of the page data (from the page of the storage device) to a memory page of the non-volatile memory device, wherein the memory page has a second page size less than the first page size.

In Example 88, the subject matter of any one of Examples 85 to 87 can optionally include that the request is a read request for reading part of the data.

In Example 89, the subject matter of any one of Examples 62 to 88 can optionally include that the memory controller configured to: receive, from a host (processing unit) via the memory interface, a read request for reading read data stored by the memory module, determine, whether the read request indicates corresponding data that are stored by the storage device and that are intended to be read by the host in future read requests, in the case that it is determined that the read request indicates the corresponding data, cache the corresponding data (from the storage device) to the (memory storage of the) non-volatile memory device (for future read access), determine, whether the read data have been frequently accessed by the host in prior read requests, and in the case that it is determined that the read data have been frequently accessed by the host in prior read requests, cache the read data (from the storage device) to the (memory storage of the) non-volatile memory device (for future read access).

In Example 90, the subject matter of Example 89 can optionally include that the memory controller is configured to: determine a number of prior read requests that accessed the read data (in a predefined time period); and determine that the read data have been frequently accessed by the host in the case that the number of prior read requests is equal to or greater than a predefined read access threshold value.

In Example 91, the subject matter of any one of Examples 62 to 90 can optionally include that the non-volatile memory device is a remanent-polarizable (e.g., ferroelectric) memory device.

In Example 92, the subject matter of any one of Examples 62 to 91 can optionally include that the memory interface is a Compute Express Link, CXL, interface.

In Example 93, the subject matter of any one of Examples 62 to 92 can optionally include that the memory module is a solid-state disc (SSD).

In Example 94, the subject matter of any one of Examples 62 to 93 can optionally include that the non-volatile storage device includes Quad-Level (memory) Cells (QLC).

In Example 95, the subject matter of any one of Examples 62 to 94 can optionally include that the non-volatile memory device is configured to store at least one Flash Translation Layer (FTL) table.

The term “connected” may be used herein with respect to nodes, terminals, integrated circuit elements, and the like, to mean electrically connected, which may include a direct connection or an indirect connection, wherein an indirect connection may only include additional structures in the current path that do not influence the substantial functioning of the described circuit or device. The term “electrically conductively connected” that is used herein to describe an electrical connection between one or more terminals, nodes, regions, contacts, etc., may be understood as an electrically conductive connection with, for example, ohmic behavior, e.g., provided by a metal or degenerate semiconductor in absence of p-n junctions in the current path. The term “electrically conductively connected” may be also referred to as “galvanically connected”.

The term “coupled to” used herein with reference to components of a memory device may be understood in that the components are directly or indirectly communicatively coupled to one another.

The terms “at least one” and “one or more” may be understood to include any integer number greater than or equal to one, i.e. one, two, three, four, [ . . . ], etc. The term “a plurality” or “a multiplicity” may be understood to include any integer number greater than or equal to two, i.e. two, three, four, five, [ . . . ], etc. The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of listed elements.

The phrase that an element or a group of elements “includes” another element or another group of elements may be used herein to mean that the other element or other group of elements may be part of the element or the group of elements or that the element or the group of elements may be configured or formed as the other element or the other group of elements (e.g., the element may be the other element).

The phrase “unambiguously assigned” may be used herein to mean a one-to-one-assignment (e.g., allocation, e.g., correspondence) or a bijective assignment. As an example, a first element being unambiguously assigned to a second element may include that the second element is unambiguously assigned to the first element. As another example, a first group of elements being unambiguously assigned to a second group of element may include that each element of the first group of elements is unambiguously assigned to a corresponding element of the second group of elements and that that corresponding element of the second group of elements is unambiguously assigned to the element of the first group of elements.

A storage device (short: storage), as described herein, may be configured to persistently, viz. non-volatilely, store data. Illustratively, the storage device may serve for permanent data storage. Thus, the storage device may store the data also once the power is removed. As an example, the storage device 104 be a non-volatile flash storage, such as a non-volatile NAND flash storage.

A memory device (short: memory) may either be volatile or non-volatile. A volatile memory may require constant power in order to store data. Thus, once the power is lost, the stored data are gone. Hence, a volatile memory may store data non-persistently. A non-volatile memory, on the other hand, may also store the data once the power is removed. Hence, a non-volatile memory may store data persistently.

A non-volatile memory device, as described herein, may be remanent-polarizable memory, such as a remanent-polarizable non-volatile random-access memory (NVRAM). The term remanent-polarizable NVRAM may refer to an NVRAM that includes a plurality of remanent-polarizable memory cells.

A remanent-polarizable memory cell may be writable into at least two (different) remanent polarizable memory states. For this, the memory cell may include a capacitive memory structure, such as a spontaneously polarizable capacitor, SPOC, structure. Therefore, the memory cell may also be referred to as a capacitive memory cell or a capacitor-type memory cell. The SPOC structure may include at least one capacitor. The capacitor may include a memory element disposed between at least two electrodes (e.g., two electrode layers). The SPOC structure may include the at least one capacitor and an access transistor. For example, the memory cell may be a one transistor, T, one capacitor, C, memory cell (1T1C cell). It is understood that this serves for illustration and that the memory cell may include more than one capacitor, thus being a one transistor multiple capacitors memory cell (1TxC cell). Thus, the memory state of the memory cell may be associated with a (remanent) polarization state of the SPOC structure. The (remanent) polarization state of the SPOC may determine the amount of charge stored therein. The amount of charge stored in the SPOC structure may be used to define the memory state of the memory cell. Thus, writing the memory cell may be associated with applying an electric field over the SPOC structure to thereby set (e.g., change) the (e.g., remanent) polarization state of the SPOC structure.

The memory element of the SPOC structure may include or may consist of a spontaneously polarizable material. For example, the spontaneously polarizable material may be a remanent polarizable material, such as a ferroelectric material, or a non-remanent polarizable material, such as an anti-ferroelectric material. A memory element including or consisting of a spontaneously polarizable material may be understood such that the memory element has (e.g., within the framework of the SPOC structure) spontaneously polarizable properties. Thus, the SPOC structure may provide a spontaneously polarizable capacitor (in some aspects also referred to as memory capacitor).

The spontaneously-polarizable memory element may show a hysteresis in the (voltage (drop) dependent) polarization. The spontaneously-polarizable memory element may show non-remanent spontaneous polarization (e.g., may show anti-ferroelectric properties), e.g., the spontaneously-polarizable memory element may have no or no substantial remanent polarization remaining in the case that no voltage drops over the spontaneously-polarizable memory element. In other aspects, the spontaneously-polarizable memory element may show remanent spontaneous polarization (e.g., may show ferroelectric properties), e.g., the spontaneously-polarizable memory element may have a remanent polarization or a substantial remanent polarization remaining in the case that no voltage drops over the spontaneously-polarizable memory element.

The terms “spontaneously polarized” or “spontaneous polarization” may be used herein, for example, with reference to the polarization capability of a material beyond dielectric polarization. A “spontaneously-polarizable” (or “spontaneous-polarizable”) material may be or may include a spontaneously-polarizable material that shows a remanence, e.g., a ferroelectric material, and/or a spontaneously-polarizable material that shows no remanence, e.g., an anti-ferroelectric material. The coercivity of the spontaneously-polarizable material may be a measure of the strength of the reverse polarizing electric field that may be required to remove a remanent polarization. In some aspects, the memory element may be remanent-polarizable, thereby providing the remanent polarization capability of the SPOC structure. In other aspects, the memory element may consist of a material that is spontaneously polarizable but shows no remanence (e.g., an anti-ferroelectric material) and additional conditions are implemented to generate an internal electric-field within the anti-ferroelectric material to thereby provide the remanent polarization capability of the SPOC structure. Hence, a non-remanent polarizable material, such as an anti-ferroelectric (“antiferroelectric”) material may exhibit remanent polarizable properties within certain structures. An internal electric-field within an anti-ferroelectric material may be caused (e.g., applied, generated, maintained, as examples) by various strategies: e.g., by implementing floating nodes that may be charged to voltages different from zero volts, and/or by implementing charge storage layers, and/or by using doped layers, and/or by using electrode layers that adapt electronic work-functions to generate an internal electric field, by using an encapsulation structure which introduces compressive stress or tensile stress onto the memory element, thereby establishing the spontaneously polarizable properties, only as examples.

A spontaneous polarization (e.g., a remanent or non-remanent spontaneous polarization) may be evaluated via analyzing one or more hysteresis measurements (e.g., hysteresis curves), e.g., in a plot of polarization, P, versus electric field, E, in which the material is polarized into opposite directions. The polarization capability of a material (dielectric polarization, spontaneous polarization, and a remanence characteristics of the polarization) may be analyzed using capacity spectroscopy, e.g., via a static (C-V) and/or time-resolved measurement or by polarization-voltage (P-V) or positive-up-negative-down (PUND) measurements. Another method for determining a polarization capability of a state-programmable memory element may include transmission electron microscopy, e.g., an electric-field dependent transmission electron microscopy.

The remanent-polarizable memory cells may be, for example, ferroelectric memory cells. In this case, the remanent-polarizable NVRAM may also be referred to as ferroelectric NVRAM (Fe-NVRAM or FeRAM).

It is understood that this serves as an example and that the non-volatile memory device, as described herein, may be based on another technology, such as being a magnetoresistive random-access memory (MRAM) or a resistive random-access memory (RRAM).

It is noted that one or more functions described herein with reference to a memory device may be accordingly part of a method, e.g., part of a method for operating a memory device. Vice versa, one or more functions described herein with reference to a method, e.g., with reference to a method for operating a memory device, may be implemented accordingly in a device or in a part of a device, for example, by a memory controller.

While the invention has been particularly shown and described with reference to specific aspects, it should be understood by those skilled in the art that various changes in form and detail may be made therein without departing from the spirit and scope of the invention as defined by the appended claims. The scope of the invention is thus indicated by the appended claims and all changes, which come within the meaning and range of equivalency of the claims, are therefore intended to be embraced.

What is claimed is:

1. A memory module comprising:
a memory interface;
a storage device for persistently storing data;
a non-volatile memory device providing a memory storage for persistently storing data and providing a write buffer configured to receive, via the memory interface, and to store corresponding data to be written to the memory module; and
a memory controller configured to write the corresponding data selectively from the write buffer to the storage device or to the memory storage.

2. The memory module according to claim 1,
wherein the memory controller is configured to write the corresponding data in response to receiving, from a host, a write command indicating whether the corresponding data are to be written to the storage device or to the memory storage.

3. The memory module according to claim 2,
wherein the write command comprises metadata indicating an address to where the corresponding data is or are to be written, wherein a translation layer indicates whether the address is associated with a location in the storage device or the memory storage.

4. The memory module according to claim 1,
wherein the memory controller is configured to select whether the corresponding data is or are to be written to the storage device or to the memory storage.

5. The memory module according to claim 1,
wherein the memory controller is configured to select whether the corresponding data is or are to be written to the storage device or to the memory storage based on a data size of the corresponding data.

6. The memory module according to claim 1,
wherein a first size of the storage device is less than one thousand times larger than a second size of the memory storage.

7. The memory module according to claim 1,
wherein the memory storage has a first tier, and wherein the storage device has a second tier higher than the first tier.

8. The memory module according to claim 1,
wherein the memory controller is configured to, in the case that the corresponding data is or are to be written to the storage device, indicate a page of the storage device as invalid prior to writing the corresponding data to the storage device, wherein the corresponding data represent(s) an update to page data stored by the page.

9. The memory module according to claim 1,
wherein the non-volatile memory device is a remanent-polarizable memory device.

10. The memory module according to claim 1,
wherein the memory module is a solid-state disc.

11. The memory module according to claim 1,
wherein the non-volatile storage device comprises Quad-Level Cells.

12. A memory module comprising:
a memory interface;
a storage device comprising a plurality of pages for persistent data storage, wherein each page of the plurality of pages has a first page size;
a non-volatile memory device comprising one or more pages for persistent data storage, wherein each page of the one or more pages has a second page size less than the first page size; and
a memory controller configured to carry out a write operation for writing data to a page of the one or more pages.

13. The memory module according to claim 12,
wherein the memory controller is configured to dynamically generate the one or more pages with the second page size being selected from a plurality of page sizes.

14. The memory module according to claim 12,
wherein the memory controller is configured to dynamically select the second page size based on a data flow to the memory module.

15. The memory module according to claim 12,
wherein the memory controller is configured to dynamically generate multiple pages, wherein each page of the multiple pages has a respective page size selected from a plurality of page sizes, wherein a first page of the multiple pages has a first respective page size and wherein a second page of the multiple pages has a second respective page size different from the first respective page size.

16. The memory module according to claim 12,
wherein the non-volatile memory device is configured to store at least one Flash Translation Layer (FTL) table; and
wherein the memory controller is configured to, when generating a page having a page size selected from a plurality of page sizes, generate a corresponding address entry in the at least one FTL table.

17. A memory module comprising:
a memory interface;
a storage device for persistently storing data;
a non-volatile memory device for persistently storing data; and
a memory controller configured to:
receive, from a host via the memory interface, a read request for reading read data stored by the non-volatile memory device or the storage device,
determine, whether the read request indicates corresponding data that is or are stored by the storage device and that are intended to be read by the host in future read requests,
in the case that it is determined that the read request indicates the corresponding data, cache the corresponding data to the non-volatile memory device, and
in the case that it is determined that the read request does not indicate the corresponding data, cache the read data to the non-volatile memory device in the case that the read data has or have been frequently accessed by the host in prior read requests.

18. The memory module according to claim 17,
wherein the memory controller is further configured to:
determine a number of prior read requests that accessed the read data; and
determine that the read data has or have been frequently accessed by the host in the case that the number of prior read requests is equal to or greater than a predefined read access threshold value.

19. The memory module according to claim 17,
wherein the frequently accessed data are a portion of page data stored in a page of the storage device, wherein the page has a first page size;
wherein the memory controller is configured to cache the frequently accessed data to the non-volatile memory device by writing the portion of the page data to a memory page of the non-volatile memory device, wherein the memory page has a second page size less than the first page size.

20. The memory module according to claim 17,
wherein the read data are a portion of page data stored in a page of the storage device, wherein the page has a first page size;
wherein the memory controller is configured to cache the read data to the non-volatile memory device by writing the portion of the page data to a memory page of the non-volatile memory device, wherein the memory page has a second page size less than the first page size.
